(19) United States
(12) Patent Application Publication
(10) Pub. No.: US 2008/0175369 A1
(43) Pub. Date: Jul. 24, 2008

(54) Method of operating a telecommunications system for providing a remotely accessible personal telephone directory

(76) Inventor: Paul D. Wilkins, Atlanta, GA (US)

Correspondence Address: WEISS & MOY PC, 4204 NORTH BROWN AVENUE, SCOTTSDALE, AZ, 85251, US

(21) Appl. No.: 11/656,030

(22) Filed: Jan. 22, 2007

(51) Int. Cl. H04M 3/493

(52) U.S. Cl. 379/218.01

(57) ABSTRACT

A method of operating a telecommunications system for providing a remotely accessible personal telephone directory is disclosed. The remotely accessible personal telephone directory may be capable of storing numerous telephone numbers and may be accessed remotely from various parts of the world. The method may include a remotely accessible personal telephone directory that comprises an additional feature on a user's existing telephone subscription service.

### RELATED APPLICATION

This non-provisional application claims priority from provisional application No. ______ entitled PERSONAL TELEPHONE DIRECTORY filed on Nov. 13, 2006 in the name of the applicant of this application.

### FIELD OF THE INVENTION

This invention relates generally to telecommunications and, more particularly, to a method of operating a telecommunications system for providing a personal telephone directory that is capable of storing numerous telephone numbers and that may be accessed remotely from various parts of the world.

### BACKGROUND OF THE INVENTION

Telephones are a significant part of everyday life for many people. Many individuals frequently use more than one telephone and therefore have more than one telephone number, such as home, work, and cellular telephone numbers. In order to reach a particular individual by telephone, it is of course necessary to know that individual's telephone number or numbers. Remembering different telephone numbers for different individuals may become difficult, due in part to the amount of telephone numbers that particular individuals may have. Further, because it is not uncommon for particular individuals to have “unlisted” telephone numbers, such telephone numbers may not be retrieved from a public telephone book or from directory assistance. The same is typically true for cellular telephone numbers. Thus, individuals have been known to keep track of telephone numbers by various methods, such as by the use of address books, notebooks, slips of paper, etc. In addition with the use of modern technology, telephone numbers may be electronically stored in directories in an individual's cellular telephone, landline telephone, personal digital assistant (“PDA”), etc.

Limitations exist with the aforementioned methods of keeping track of telephone numbers. For example, sometimes there are limits with respect to the amount of telephone numbers that may be stored in an electronic directory on a landline telephone, cellular telephone, or PDA. Further, sometimes individuals may program different telephone numbers into a landline telephone, but fail to also program such telephone numbers into the individual's cellular telephone or PDA, and vice versa. Further still, sometimes individuals forget to bring their cellular telephones with them when leaving their homes, places of work, etc. As a still further example, sometimes a cellular telephone's battery runs out and the telephone becomes unusable. All of these limitations may become problematic when an individual needs to make a telephone call but does not have the telephone number handy and cannot retrieve the telephone number from the individual's cellular telephone, landline telephone, or PDA, etc.

It would therefore be convenient for individuals to have personal telephone directories that are capable of maintaining lists of all the telephone numbers that individuals wish to have in those directories. Such personal telephone directories may be less burdensome than having to program different telephone numbers into multiple directories, such as electronic landline, cellular telephone, and PDA directories. Maintaining such personal telephone directories may also be less expensive than contacting directory assistance. It would also be convenient for an individual to be able to retrieve from a personal telephone directory various personal numbers and call those various personal numbers from anywhere in the world.

A need therefore exists for a method of operating a telecommunications system for providing a personal telephone directory system that is capable of storing numerous telephone numbers and that may be accessed remotely from various parts of the world.

The present invention satisfies these needs and provides other, related advantages.

### SUMMARY OF THE INVENTION

In accordance with an embodiment of the present invention, a method of operating a telecommunications system for providing a remotely accessible personal telephone directory is disclosed, The method comprises the steps of: providing a telephone service subscription for a user, wherein the telephone service subscription includes a personal telephone number and an electronic personal telephone directory for the user; accepting an inputting of the user's personal telephone number; accepting an inputting of one of a personal code and pin number; prompting the user to enter a number corresponding to a service of the electronic personal telephone directory; prompting the user whether the user desires a directory listing; accepting an inputting of one of a designated key and keys to retrieve the electronic personal telephone directory; prompting the user to enter a first letter of one of a last name and business name of a desired contact; prompting the user whether a desired directory listing has been reached; accepting an inputting of a designated key to retrieve the desired directory listing; and providing the user with a telephone number for the desired directory listing.

In accordance with another embodiment of the present invention, a method of operating a telecommunications system for providing a remotely accessible personal telephone directory is disclosed. The method comprises the steps of: providing a telephone service subscription for a user, wherein the telephone service subscription includes a personal telephone number and an electronic personal telephone directory for the user; accepting an inputting of a designated telephone number to reach the electronic personal telephone directory; accepting an inputting of one of a personal code and pin number; prompting the user to enter a number corresponding to a service of the electronic personal telephone directory; prompting the user whether the user desires a directory listing; accepting an inputting of one of a designated key and keys to retrieve the electronic personal telephone directory; prompting the user to enter a first letter of one of a last name and business name of a desired contact; prompting the user whether a desired directory listing has been reached; accepting an inputting of a designated key to retrieve the desired directory listing; and providing the user with a telephone number for the desired directory listing.

In accordance with a further embodiment of the present invention, a method of operating a telecommunications system for providing a remotely accessible personal telephone directory is disclosed. The method comprises the steps of: providing a telephone service subscription for a user, wherein the telephone service subscription includes a personal telephone number and an electronic personal telephone directory for the user; accepting an inputting of the user's personal telephone number; accepting an inputting of one of a personal code and pin number; prompting the user to enter a number corresponding to a service of the electronic personal telephone directory; accepting an inputting of one of a designated key and keys to store information in the electronic personal telephone directory; prompting the user to enter letters of one of a last name and business name of a desired contact; and accepting an inputting of a sequence of designated keys to log in the one of a last name and business name and a corresponding telephone number.

### BRIEF DESCRIPTION OF THE DRAWINGS

FIG. 1 is a flow chart showing the steps involved in an embodiment of the present invention.

FIG. 2 is a flow chart showing the steps involved in an embodiment of the present invention.

FIG. 3 is a flow chart showing the steps involved in an embodiment of the present invention.

FIG. 4 is a flow chart showing the steps involved in an embodiment of the present invention.

### DETAILED DESCRIPTION OF THE PREFERRED EMBODIMENTS

The present invention allows a user to access a personal telephone directory in order to retrieve and call various stored personal telephone numbers from any virtually any telephone in the world. A remotely accessible personal telephone directory is a directory designed for the purpose of allowing any telephone subscriber his or her personal directory of names and corresponding telephone numbers as an additional service provided with the subscriber's telephone service. By calling his or her personal telephone number from an outside telephone and following a series of steps, a user of a remotely accessible personal telephone directory may retrieve personal telephone numbers that have been stored in the remotely accessible personal telephone directory. The remotely accessible personal telephone directory may also be accessed by virtue of a designated telephone number that the subscriber may call using his or her telephone that is associated with the remotely accessible personal telephone directory.

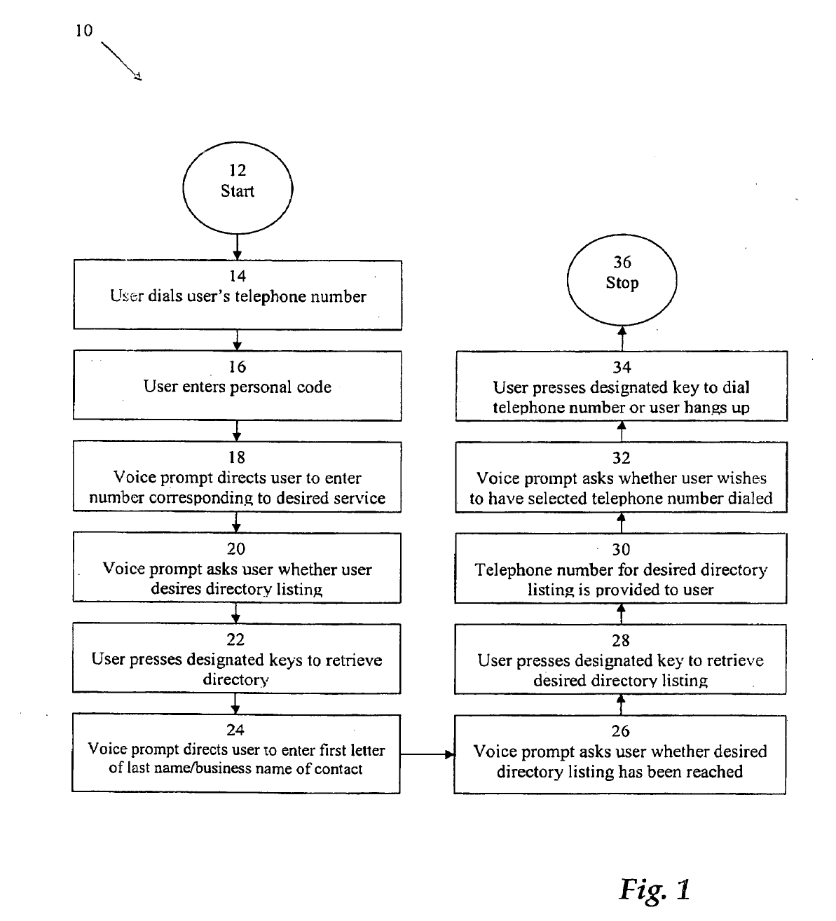

Referring first to FIG. 1, a flow chart shows the steps of a method of operating a telecommunications system for providing a remotely accessible personal telephone directory 10 (hereinafter the “method 10”), consistent with an embodiment of the present invention. In this embodiment, an outside telephone is employed to access a user's remotely accessible personal telephone directory.

A preferred embodiment of the method 10 comprises a series of steps. First, the user dials his or her telephone number 14. Next, the user enters a personal code or pin number 16, by using the keypad of the outside telephone. For example, a user may enter a code such as “*1927.” In the next step, a voice prompt directs the user to enter a number corresponding to a particular service that the user would like to use 18. For example, in a preferred embodiment, a user may enter “*1” to locate a telephone number, “*2” to enter a telephone number, “*3” to delete a previously entered telephone number, “*4” to block access to the user's telephone number by an unauthorized party, and “*5” to unblock the user's telephone number. Different numbers and/or keys may be designated for each of the aforementioned services, as desired. In addition, it may be desired to include other services, as appropriate. Once the user has selected a particular service, a voice prompt then asks the user whether the user would like a listing from his or her remotely accessible personal telephone directory 20. If the user desires such a listing, the user may then press a designated key or keys to retrieve the directory 22. For example, the user may press the star key (*) followed by the star key. Next, a voice prompt will direct the user to press the number corresponding to the first letter of a last name or business name of a person whom the user wishes to contact 24. In the event that the user has stored multiple entries beginning with the same letter, such as the letter C, the user may then press a first designated key, such as 1, in order to scroll backward through the directory or a second designated key, such as 3, to scroll forward through the directory, until reaching the desired entry. In the next step, a voice prompt asks the user whether the desired directory listing has been reached 26. If the desired directory listing has been reached, then the user presses a designated key in order to retrieve the desired directory listing 28. For example, the user may press the pound key (#). Next, the telephone number for the desired directory listing is provided to the user 30. In the next step, a voice prompt asks the user whether the user wishes to have the selected telephone number dialed 32. If so, the user then presses a designated key or keys to dial the selected telephone number, and if not, the user simply hangs up the telephone 34. For example, the user may press the pound key in order to have the selected telephone number dialed. It may also be desired to omit steps 32 and 34.

Preferably, in this embodiment, the remotely accessible personal telephone directory is configured such that when a user dials his or her remotely accessible personal telephone directory from an outside telephone, the remotely accessible personal telephone directory may be reached virtually immediately. This may be accomplished by the user pressing a designated sequence of keys, such as the star key immediately followed by the 3 key, after the user has dialed his or her personal telephone number. After the designated sequence of keys has been pressed, the user may be immediately transferred to his or her remotely accessible personal telephone directory. Thus, a situation may be avoided wherein the user is prevented from reaching his or her remotely accessible personal telephone directory by the act of another person picking up the handset of the telephone on which the remotely accessible personal telephone directory is programmed at the same time that the user dials his or her personal telephone number.

In the event that the user is using a pay telephone to reach his or her remotely accessible personal telephone directory, it may be desired for an extra fee to be charged which may then be billed to the user's personal telephone service that he or she is required to call in order to reach his or her remotely accessible personal telephone directory.

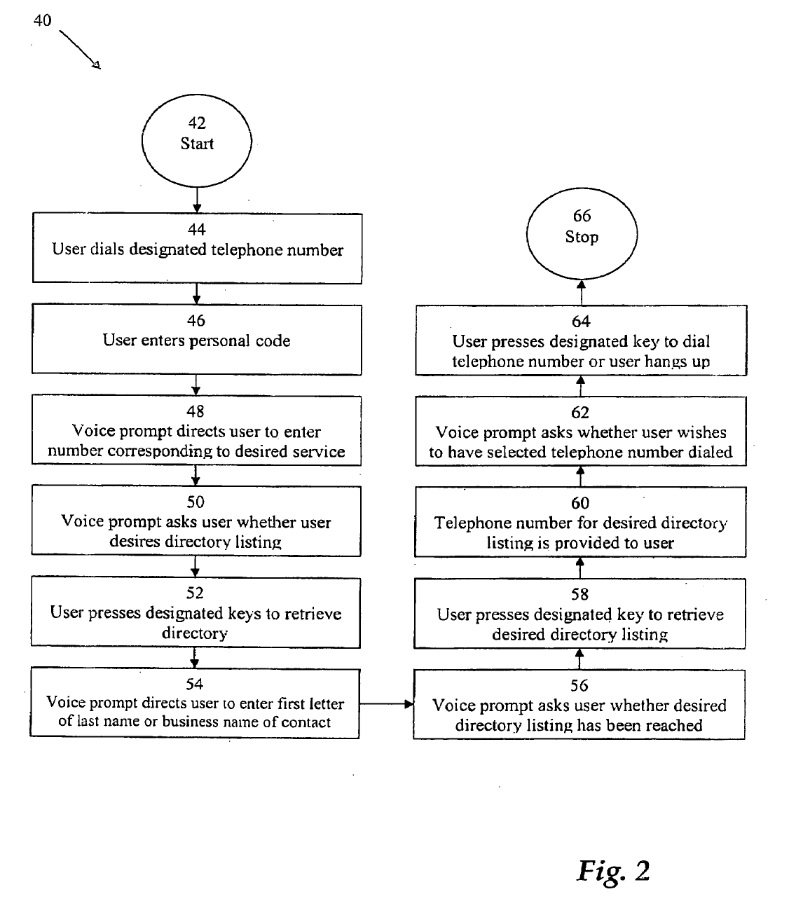

Referring now to FIG. 2, a flow chart shows the steps of a method of operating a telecommunications system for providing a remotely accessible personal telephone directory 40 (hereinafter the “method 40”), consistent with an embodiment of the present invention. In this embodiment, a user employs his or her personal telephone in order to access the remotely accessible personal telephone directory.

A preferred embodiment of the method 40 comprises a series of steps. First, the user dials a designated telephone number 44. The designated telephone number should be a number different from the user's telephone number with which the user's remotely accessible personal telephone directory is associated. Next, the user enters a personal code or pin number 46, by using the keypad of the user's personal telephone. For example, as with the method 10, a user may enter a code such as “*1927.” In the next step of the method 40, a voice prompt directs the user to enter a number corresponding to a particular service that the user would like to use 48. For example, in a preferred embodiment, a user may enter “*1” to locate a telephone number, “*2” to enter a telephone number, “*3” to delete a previously entered telephone number. “*4” to block access to the user's telephone number by an unauthorized party, and “*5” to unblock the user's telephone number. Different numbers and/or keys may be designated for each of the aforementioned services, as desired. In addition, it may be desired to include other services, as appropriate. Once the user has selected a particular service a voice prompt then asks the user whether the user would like a listing from his or her remotely accessible personal telephone directory 50. If the user desires such a listing, the user may then press a designated key or keys to retrieve the directory 52. For example, the user may press the star key followed by the star key. Next, a voice prompt will direct the user to press the number corresponding to the first letter of a last name or business name of a person whom the user wishes to contact 54. In the event that the user has stored multiple entries beginning with the same letter, such as the letter C, the user may then press a first designated key such as 1, in order to scroll backward through the directory or a second designated key, such as 3, to scroll forward through the directory, until reaching the desired entry. In the next step, a voice prompt asks the user whether the desired directory listing has been reached 56. If the desired directory listing has been reached, then the user presses a designated key in order to retrieve the desired directory listing 58. For example, the user may press the pound key. Next, the telephone number for the desired directory listing is provided to the user 60. In the next step, a voice prompt asks the user whether the user wishes to have the selected telephone number dialed 62. If so, the user then presses a designated key or keys to dial the selected telephone number, and if not, the user may simply hang up the telephone 64. For example, the user may press the pound key in order to have the selected telephone number dialed. It may be also desired to omit steps 62 and 64.

In a preferred embodiment of the method 40, for a user subscribing to a caller ID service, it may be relatively easy to enter a name and corresponding telephone number into the remotely accessible personal telephone directory after someone has called the user's telephone. After receiving a telephone call, such a user may log the corresponding telephone number into the user's remotely accessible personal telephone directory and have the telephone number automatically categorized. This may be accomplished with the user pressing a sequence of designated keys, such as the pound key followed by the user's personal code or pin number, followed by “*45.” In the event that the user is engaged in a call at the time he or she wishes to enter a telephone number, preferably, the user may simply “click over” to another line (in a manner similar to using a standard three-way calling system), then enter his or her personal code or pin number and enter an appropriate key or sequence of keys for logging a telephone number into the remotely accessible personal telephone directory, as described above and below.

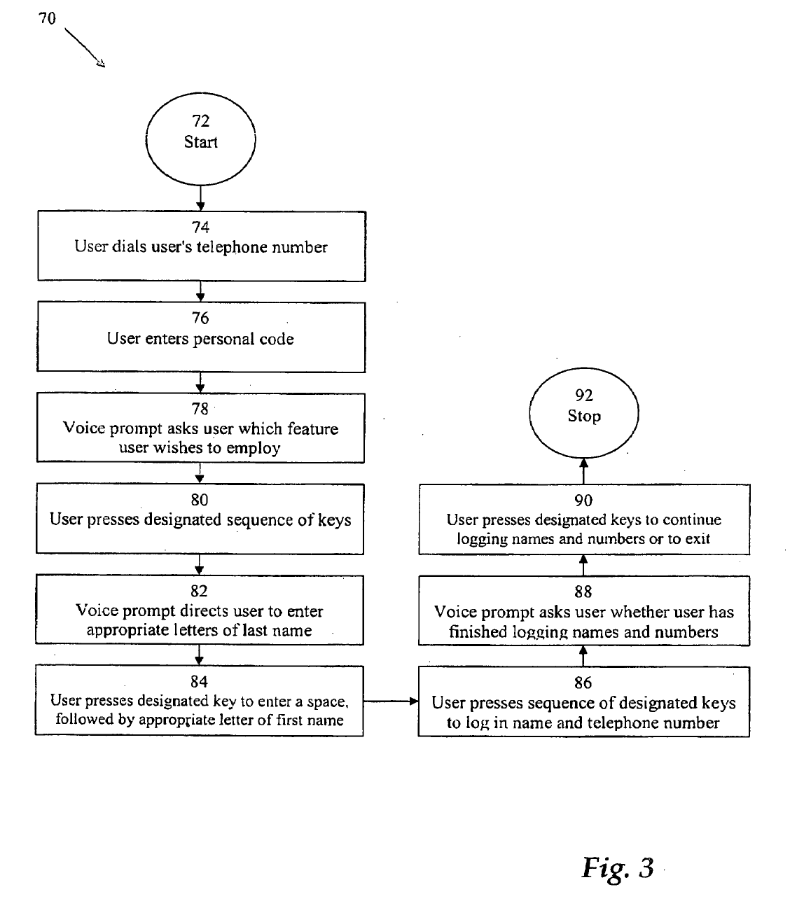

Referring now to FIG. 3, a flow chart shows the steps of a method of operating a telecommunications system for providing a remotely accessible personal telephone directory 70 (hereinafter the “method 70”), consistent with an embodiment of the present invention. In this embodiment, steps for storing information in a user's remotely accessible personal telephone directory are disclosed.

In the method 70, in order to enter a new telephone number in a user's remotely accessible personal telephone directory, use of a touch tone telephone is preferred. To enter a new telephone number, a user preferably follows a series of steps. First, the user dials his or her personal telephone number 74. Next, the user enters a personal code or pin number 76. For example, as with the methods 10 and 40, a user may enter a code such as “*1927.” Next, a voice prompt asks the user which feature of the remotely accessible personal telephone directory the user wishes to employ 78. In response, the user then presses a designated sequence of key 80. For example, the user may press the pound key immediately followed by the 2 key.

In the next step, a voice prompt directs the user to enter the letters of the last name of the person Whose telephone number the user wishes to enter into the remotely accessible personal telephone directory 82. In order to do so, the user would use a standard keypad found on most telephones, wherein, for example, the 2 key represents the letters ABC, the 3 key represents the letters DEF, the 4 key represents the letters GHI, the 5 key represents the letters JKL, the 6 key represents the letters MNO, the 7 key represents the letters PQRS, the 8 key represents the letters TUV, and the 9 key represents the letters WXYZ. As an example, in order to enter the last name of Canton, a user would press the 2 key three times to reach the letter C, then press the 2 key one time to reach the letter A, then press the 6 key twice to reach the letter N, then press the 8 key once to reach the letter T, then press the 6 key three times to reach the letter O, and finally press the 6 key twice to reach the letter N. In order to enter the first initial of the person for whom the last name was just entered, the user would then press a designated key to enter a space 84, followed by a key corresponding to the first initial of the first name to be entered. To enter a space, for example, the user may press the star key.

Once the desired name has been entered, the user then presses a sequence of designated keys in order to log the name and corresponding telephone number into the remotely accessible personal telephone directory 86. Such a sequence of designated keys could consist of, for example, the star key immediately followed by the key. Once the user has performed this process, a voice prompt asks the user whether the user has finished logging telephone numbers into the remotely accessible personal telephone directory or whether the user desires to log additional telephone numbers into the remotely accessible personal telephone directory 88. Next, the user then presses a designated key, depending on whether the user desires either to log additional telephone numbers into the remotely accessible personal telephone directory or to exit the system 90. For example, if the user desires to enter additional telephone numbers, the user may press the 2 key. If the user desires to exit the system, the user may press a sequence of designated keys, such as the pound key immediately followed by the pound key.

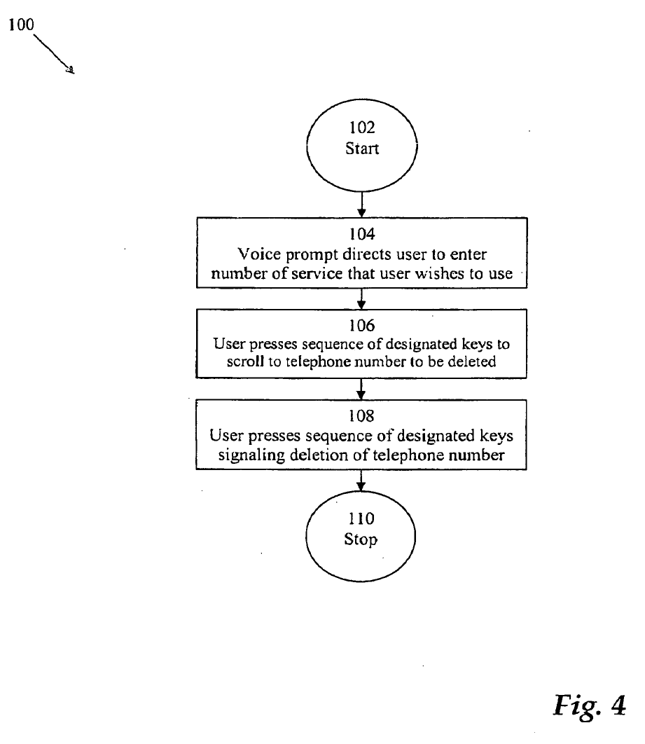

Referring now to FIG. 4, a flow chart shows the steps of a method of operating a telecommunications system for providing a remotely accessible personal telephone directory 100 (hereinafter the “method 100”), consistent with an embodiment of the present invention. In this embodiment, steps for deleting information from a user's remotely accessible personal telephone directory are disclosed.

In the method 100, if the user desires to delete a telephone number or numbers from the remotely accessible personal telephone directory, the user preferably does so from the beginning of the system, following a preferred series of steps. In the first step, a voice prompt directs the user to enter the number of the service that he or she would like to use 104. Next, the user presses a sequence of designated keys in order to scroll to the telephone number that the user wishes to delete 106. For example, the user may press the pound key immediately followed by the 3 key to accomplish this step. Once the user reaches the telephone number to be deleted, the user then presses a sequence of designated keys, signaling the deletion of the telephone number 108. For example, such designated keys may consist of the star key followed by the 6 key.

While the invention has been particularly shown and described with reference to the preferred embodiments thereof, it will be understood by those skilled in the art that the foregoing and other changes in form and details may be made therein without departing from the spirit and scope of the invention. For example, it may be desired to employ voice activation with any of foregoing embodiments.

I claim:

1. A method of operating a telecommunications system for providing a remotely accessible personal telephone directory, comprising the steps of:
providing a telephone service subscription for a user, wherein the telephone service subscription includes a personal telephone number and an electronic personal telephone directory for the user;
accepting an inputting of the user's personal telephone number;
accepting an inputting of one of a personal code and pin number;
prompting the user to enter a number corresponding to a service of the electronic personal telephone directory;
prompting the user whether the user desires a directory listing;
accepting an inputting of one of a designated key and keys to retrieve the electronic personal telephone directory;
prompting the user to enter a first letter of one of a last name and business name of a desired contact;
prompting the user whether a desired directory listing has been reached;
accepting an inputting of a designated key to retrieve the desired directory listing; and
providing the user with a telephone number for the desired directory listing.

2. The method of claim 1, wherein the one of the personal code and pin number consists of a four-digit number.

3. The method of claim 1, wherein the service of the electronic personal telephone directory is one of locating a telephone number, entering a telephone number, deleting a previously entered telephone number, blocking access to the user's telephone number by an unauthorized party, and unblocking the user's telephone number.

4. The method of claim 1, wherein the number corresponding to a service of the electronic personal telephone directory is one of the number 1 for locating a telephone number, the number 2 for entering a telephone number, the number 3 for deleting a previously entered telephone number, the number 4 for blocking access to the user's telephone number by an unauthorized party, and the number 5 for unblocking the user's telephone number.

5. The method of claim 1, wherein the one of a designated key and keys to retrieve the electronic personal telephone directory consists of a star key followed by a star key.

6. The method of claim 1, wherein the designated key to retrieve the desired directory listing consists of a pound key.

7. The method of claim 1 further comprising the steps of:
prompting the user whether the user wishes to have the telephone number for the desired directory listing dialed; and
pressing a designated key to dial the telephone number.

8. The method of claim 1 further comprising the step of terminating access to the electronic personal telephone directory upon a hanging up of the telephone.

9. A method of operating a telecommunications system for providing a remotely accessible personal telephone directory, comprising the steps of:
providing a telephone service subscription for a user, wherein the telephone service subscription includes a personal telephone number and an electronic personal telephone directory for the user;
accepting an inputting of a designated telephone number to reach the electronic personal telephone directory;
accepting an inputting of one of a personal code and pin number;
prompting the user to enter a number corresponding to a service of the electronic personal telephone directory;
prompting the user whether the user desires a directory listing;
accepting an inputting of one of a designated key and keys to retrieve the electronic personal telephone directory;
prompting the user to enter a first letter of one of a last name and business name of a desired contact:
prompting the user whether a desired directory listing has been reached;
accepting an inputting of a designated key to retrieve the desired directory listing; and
providing the user with a telephone number for the desired directory listing.

10. The method of claim 9, wherein the one of the personal code and pin number consists of a four-digit number.

11. The method of claim 9, wherein the service of the electronic personal telephone directory is one of locating a telephone number, entering a telephone number, deleting a previously entered telephone number, blocking access to the user's telephone number by an unauthorized party, and unblocking the user's telephone number.

12. The method of claim 9, wherein the number corresponding to a service of the electronic personal telephone directory is one of the number 1 for locating a telephone number, the number 2 for entering a telephone number, the number 3 for deleting a previously entered telephone number, the number 4 for blocking access to the user's telephone number by an unauthorized party, and the number 5 for unblocking the user's telephone number.

13. The method of claim 9, wherein the one of a designated key and keys to retrieve the electronic personal telephone directory consists of a star key followed by a star key.

14. The method of claim 9, wherein the designated key to retrieve the desired directory listing consists of a pound key.

15. The method of claim 9 further comprising the steps of:
prompting the user whether the user wishes to have the telephone number for the desired directory listing dialed; and
accepting an inputting of a designated key to dial the telephone number.

16. The method of claim 9 further comprising the step of terminating access to the electronic personal telephone directory upon a hanging up of the telephone.

17. A method of operating a telecommunications system for providing a remotely accessible personal telephone directory, comprising the steps of:
providing a telephone service subscription for a user, wherein the telephone service subscription includes a personal telephone number and an electronic personal telephone directory for the user,
accepting an inputting of the user's personal telephone number,
accepting an inputting of one of a personal code and pin number;
prompting the user to enter a number corresponding to a service of the electronic personal telephone directory;
accepting an inputting of one of a designated key and keys to store information in the electronic personal telephone directory;
prompting the user to enter letters of one of a last name and business name of a desired contact; and
accepting an inputting of a sequence of designated keys to log in the one of a last name and business name and a corresponding telephone number.

18. The method of claim 17, wherein the one of a designated key and keys to store information in the electronic personal telephone directory consists of the pound key followed by the 2 key.

19. The method of claim 17, wherein the sequence of designated keys consists of the star key followed by the 1 key.

20. The method of claim 17 further comprising the steps of:
prompting the user whether the user has finished logging in names and telephone numbers; and
accepting an inputting of one of a designated key to continue logging in names and telephone numbers and a designated key to exit.
